(19) United States
(12) Patent Application Publication
(10) Pub. No.: US 2011/0092283 A1
(43) Pub. Date: Apr. 21, 2011

(54) Game terminal

(76) Inventors: Joseph Levitan, Concord (CA); Boris Itskov, Concord (CA); Igor Starovoitov, Concord (CA); Genadi Peari, Concord (CA)

(21) Appl. No.: 12/923,730

(22) Filed: Oct. 5, 2010

(30) Foreign Application Priority Data
Oct. 6, 2009 (CA) 2,681,684

(51) Int. Cl. A63F 13/00; A63F 9/24

(52) U.S. Cl. 463/31; 463/35

(57) ABSTRACT

The game terminal is designed to be structurally strong while providing good access to various electronic controls of the game and music system, and the electronic components of the payment devices. The terminal is horizontally divided into lower, mid, intermediate and upper portions. The two center portions include hinged front face panels to provide efficient access to internal components that preferably have been divided into modular components.

### FIELD OF THE INVENTION

The present application relates to a game terminal, and in particular to a game terminal suitable for use in casinos.

### BACKGROUND OF THE INVENTION

Game terminals for arcades and casinos are well known and can include a number of different user inputs in combination with at least one video output device for allowing the play of games. These game terminals also include an audio system for enhancing the game experience and/or allowing the play of music.

To assist in the promotion of the games, most free standing game terminals include a marquee portion that may include lighting or providing information with respect to the particular game available on the game terminal.

The present invention provides a number of improvements with respect to game terminals and allows for increased flexibility with respect to both the audio capabilities and the video screen capabilities.

### SUMMARY OF THE INVENTION

A game terminal according to the present invention comprises a terminal frame divided into a lower portion, a mid portion, an intermediate portion and an upper portion. The mid portion and the intermediate portion are each vertically split and include a hinged axis panel pivotal about a vertical edge of the terminal to provide front service access to the mid and intermediate portions. The terminal also includes an elongate horizontally extending speaker system at a front face of the terminal at a junction of the intermediate and the upper portions.

A game terminal according to an aspect of the invention includes as part of said upper portion a removable front face supported by a rear frame wherein the removable front face is replaceable allowing the front face to support a marquee panel or a video display screen.

In a further aspect of the invention the game terminal includes a series of power and communication ports accessible by accessing the intermediate portion allowing a video display screen supported in the removable front face to be electronically connected to other electronic components of said game terminal.

### BRIEF DESCRIPTION OF THE DRAWINGS

Preferred embodiments of the invention are shown in the drawings, wherein:

FIG. 1 is a front perspective view of the game terminal;

FIG. 2 is a rear perspective view of the game terminal;

FIG. 3 is a front view of the game terminal;

FIG. 4 is a back view of the game terminal;

FIG. 5 is a right side view of the game terminal;

FIG. 6 is a left side view of the game terminal;

FIG. 7 is a top view of the game terminal;

FIG. 8 is a bottom view of the game terminal;

FIG. 9 is a front view of the game terminal with two access panels shown in an open position;

FIG. 10 is an enlarged view of coin hoppers used in the game terminal;

FIG. 11 is an enlarged view of a coin sorter mechanism;

FIG. 12 is a front perspective view of one of the access panels in an open position;

FIG. 13 is an enlargement of a marquee portion of the game terminal;

FIG. 14 is a front perspective view showing details of the sound system of the game terminal;

FIG. 15 is an enlargement of the control unit of the sound system;

FIG. 16 shows additional details of the sound system of FIG. 15;

FIG. 17 shows a speaker arrangement;

FIG. 18 shows enlargements of the speaker system of FIG. 17;

FIG. 19 is a front perspective of the game terminal and illustrates certain components of the electronics of the game terminal;

FIG. 20 shows the control unit for the game portion of the game terminal;

FIG. 21 shows additional details of the controls of the game terminal;

FIG. 22 shows additional details of a power supply arrangement;

FIG. 23 shows further details of the power supply arrangement;

FIG. 24 shows details of the marquee;

FIG. 25 is similar to FIG. 24 but from the reverse direction showing details of the marquee;

FIG. 26 illustrates lighting details provided at a lower portion on the game terminal;

FIG. 27 shows additional details of the mounting bracket used in FIG. 26;

FIG. 28 is a front view of the inner electronics box;

FIG. 29 shows various components of the inner electronics box in exploded perspective view;

FIG. 30 shows a power supply unit; and FIG. 31 shows an exploded perspective view of the power supply unit.

### DETAILED DESCRIPTION OF THE PREFERRED EMBODIMENTS

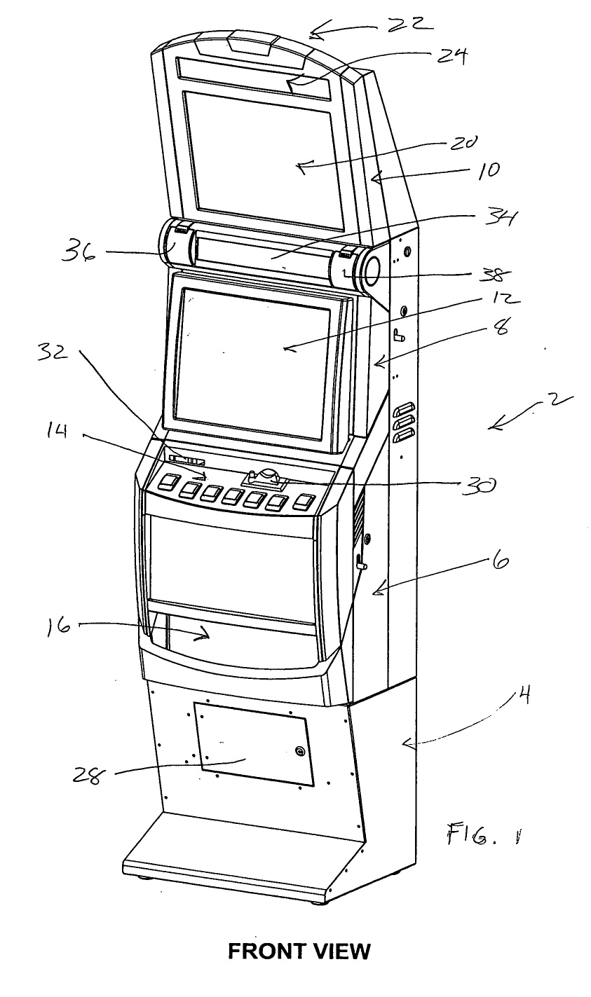

The game terminal 2 shown in FIG. 1 includes a base portion 4, a mid portion 6 an intermediate portion 8 and an upper portion 10. The intermediate portion 8 includes a video display screen 12 and the mid portion 6 includes the user control input panel shown as 14. Different user inputs can be provided and the video display screen 12 can also be a touch screen. The game terminal shown is specifically designed for casinos and thus there is a large hopper 16 provided at the base of the mid portion 6 for providing coin or banknote payouts.

The upper portion 10 includes a further screen or panel 20. The further screen or panel can include merely a marquee glass panel that provides advertising with respect to the particular game that the terminal is providing or it could be a further video display screen. Preferably, the game terminal also includes a lighted attract portion 22 provided at the upper edge of the terminal. There is also a further signage portion shown as 24.

The base portion 4 also includes a closed access port shown as 28. This is typically used for service of the game terminal.

In the embodiments shown there is a coin slot 30 and a ticket or card slot 32 to allow for payment. Other payment arrangements can be provided

The game terminal also includes an audio output system and this system includes the mid-range speaker 34, a first tweeter shown as 36 and a second tweeter shown as 38. This audio output system is provided between the intermediate portion 8 and the upper portion 10. This position is generally at the user's head height and as such provides effective audio output.

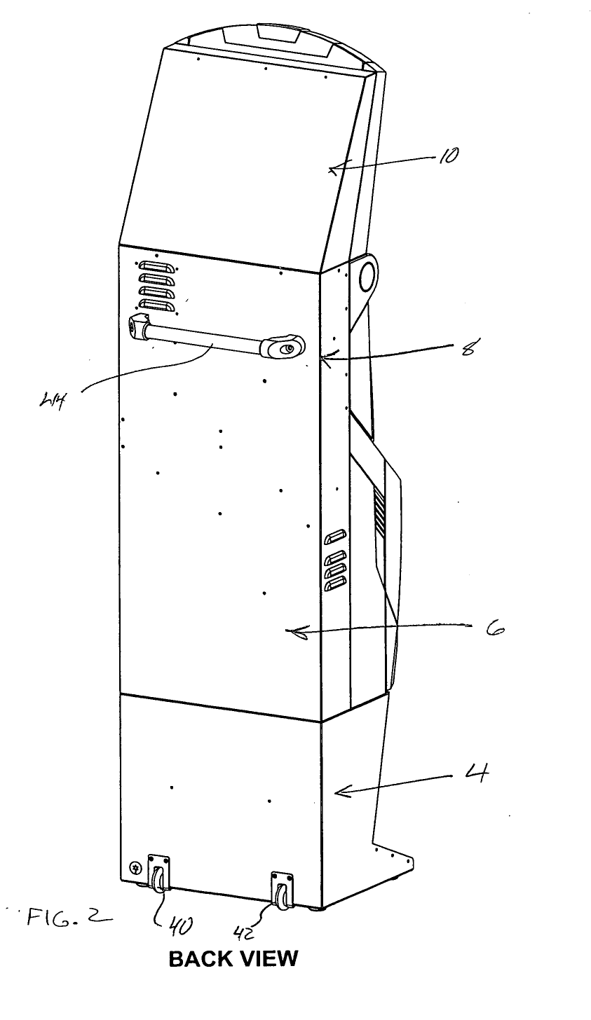

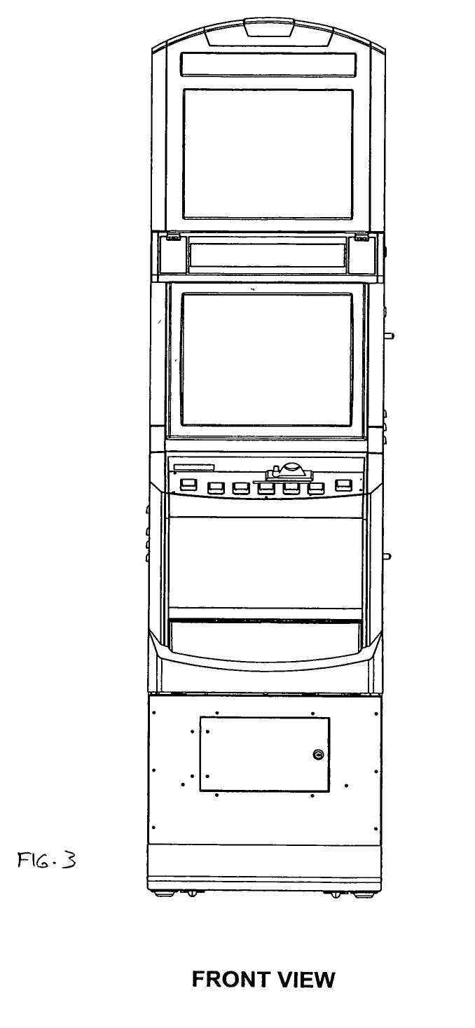

The rear perspective view of FIG. 2 shows castor wheels 40 and 42 provided at the base rear edge and a tilt handle 44 projecting from the rear portion of the game terminal. The handle 44 allows a user to tilt the terminal towards him and allows movement of the terminal using the castor wheels 40 and 42.

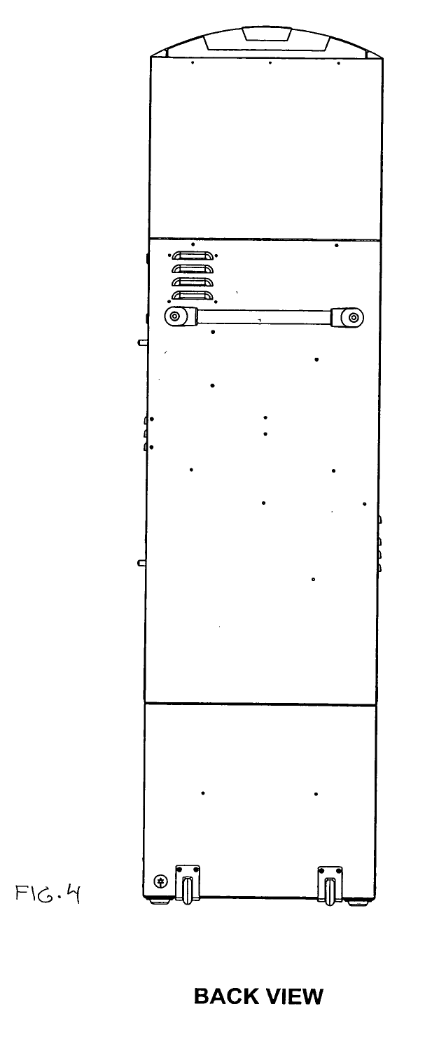

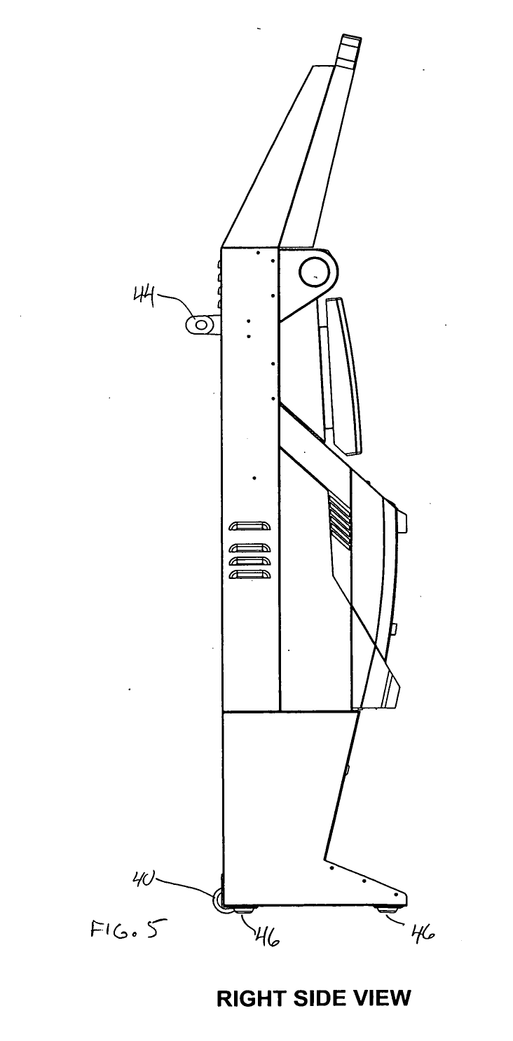

The side views of FIGS. 5 and 6 show how the video display screen 12 projects slightly outwardly from the cabinet and is positioned above the user input panel 14. These side views also illustrate how the terminal, when in the upright position, is supported by the feet shown as 46.

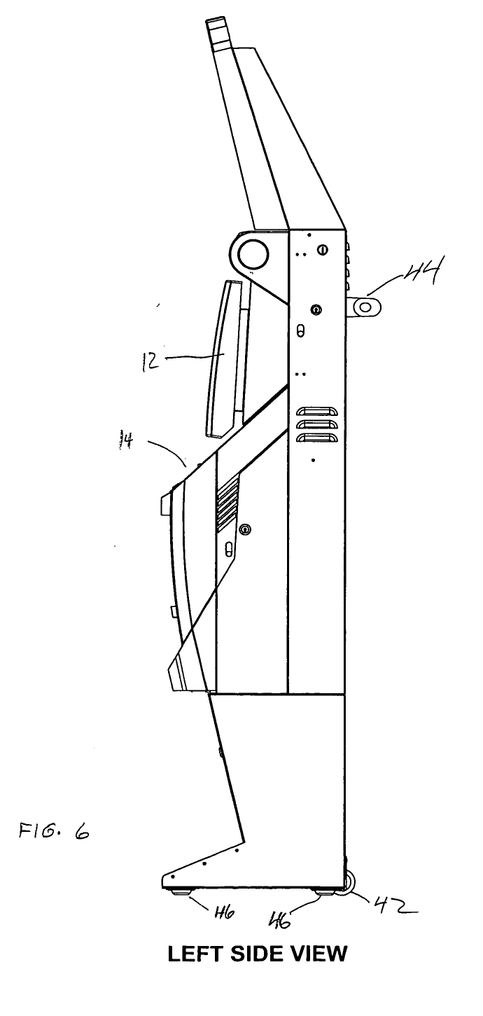

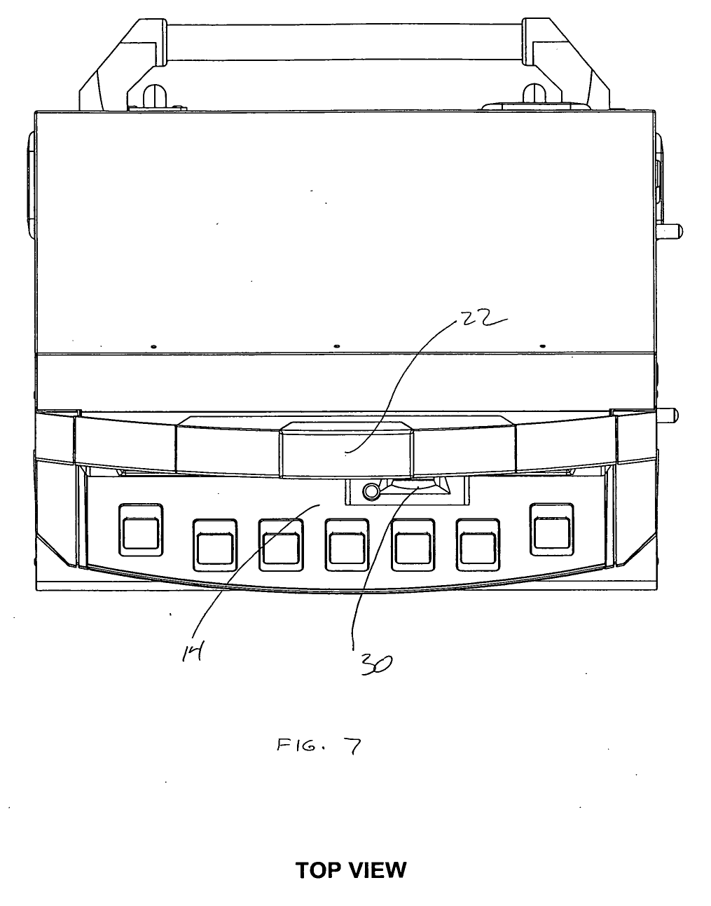

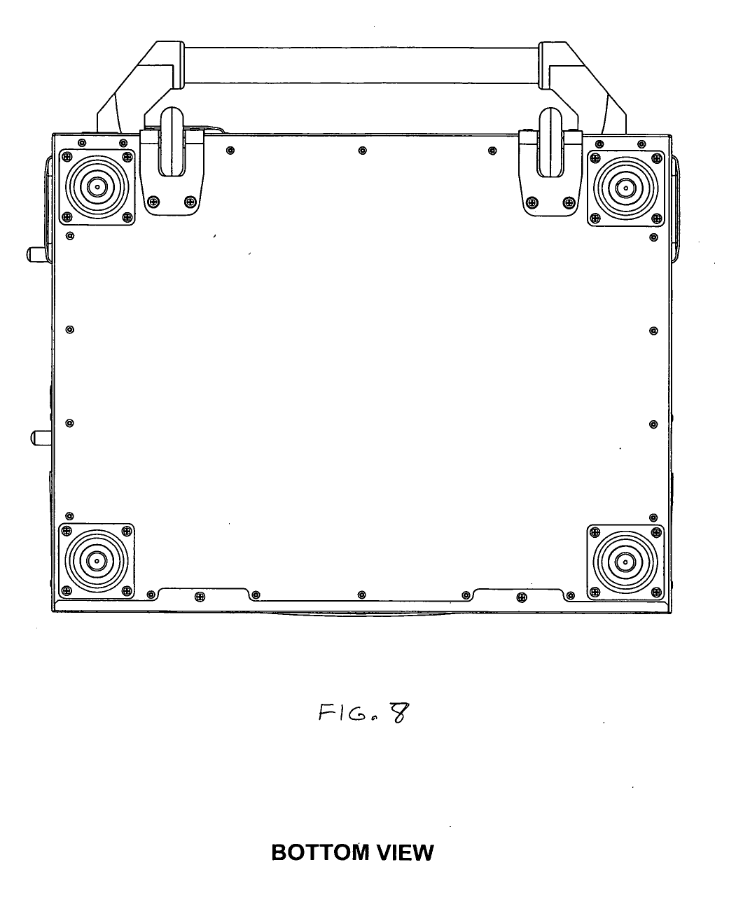

The front view of FIG. 9 shows certain details of the game terminal 2. In particular, the mid portion 6 and the intermediate portion 8 are vertically hinged along one side and have the hinged access panels 7 and 9 respectively to allow access to the inner workings of the terminal. Each of these hinged access panels 7 and 9 are normally in a locked condition and only available to service personnel. The hinged access panel 7 includes access to various payment devices provided in the mid portion 6. In particular, this includes a coin acceptor 50 that receives coins from the coin slot 30 and determines the authenticity of the coins. If the coins are determined to be authentic, they are passed to the coin sorter shown as 52. The coins are then sorted into proper denominations and deposited into one of the coin hoppers shown as 54 and 56. The access panels preferably support components to improve access.

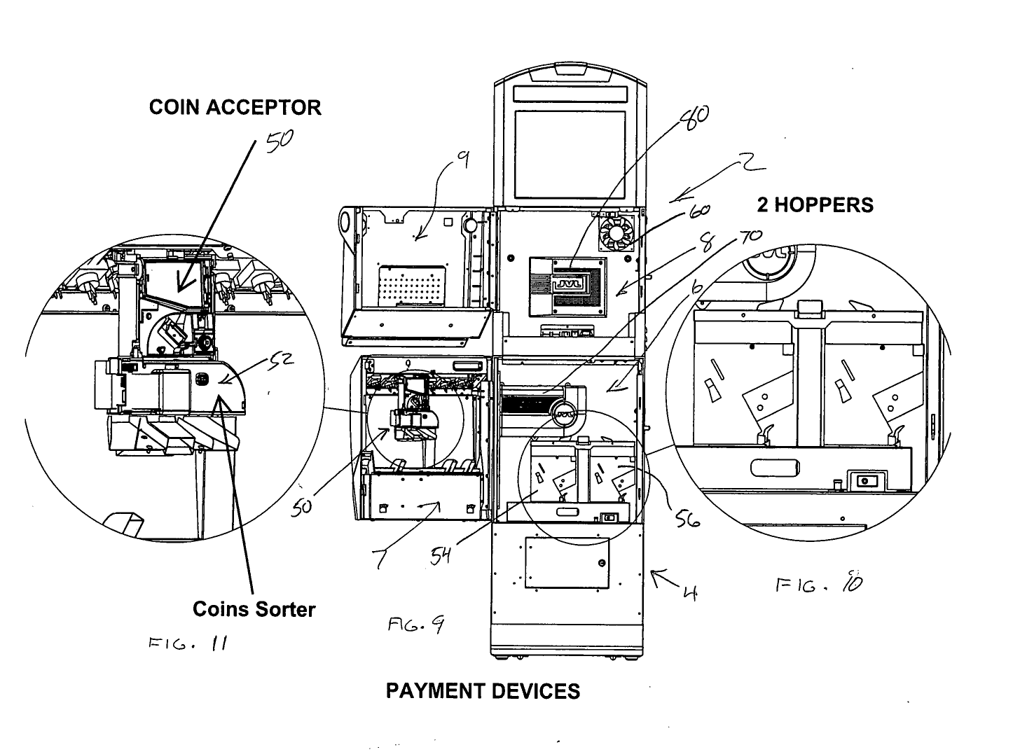

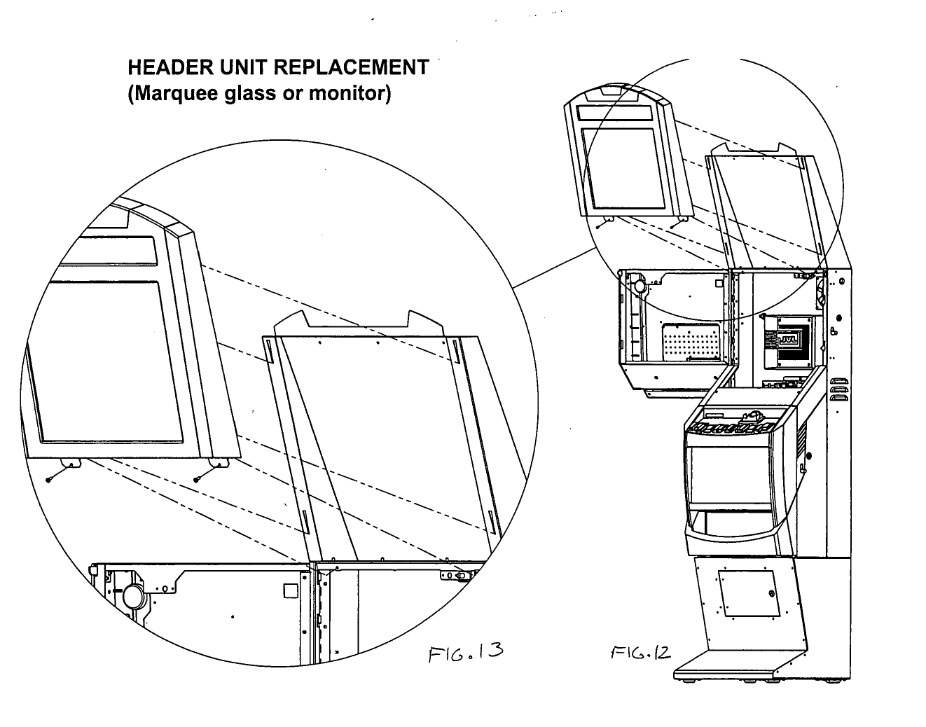

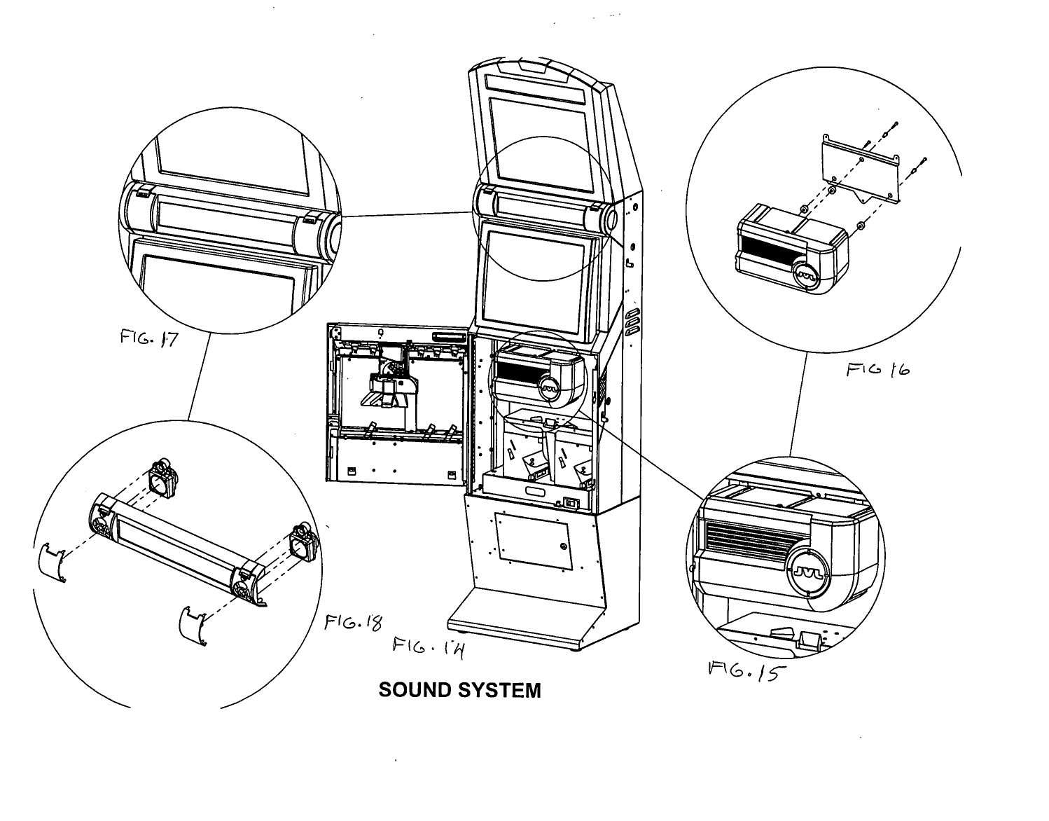

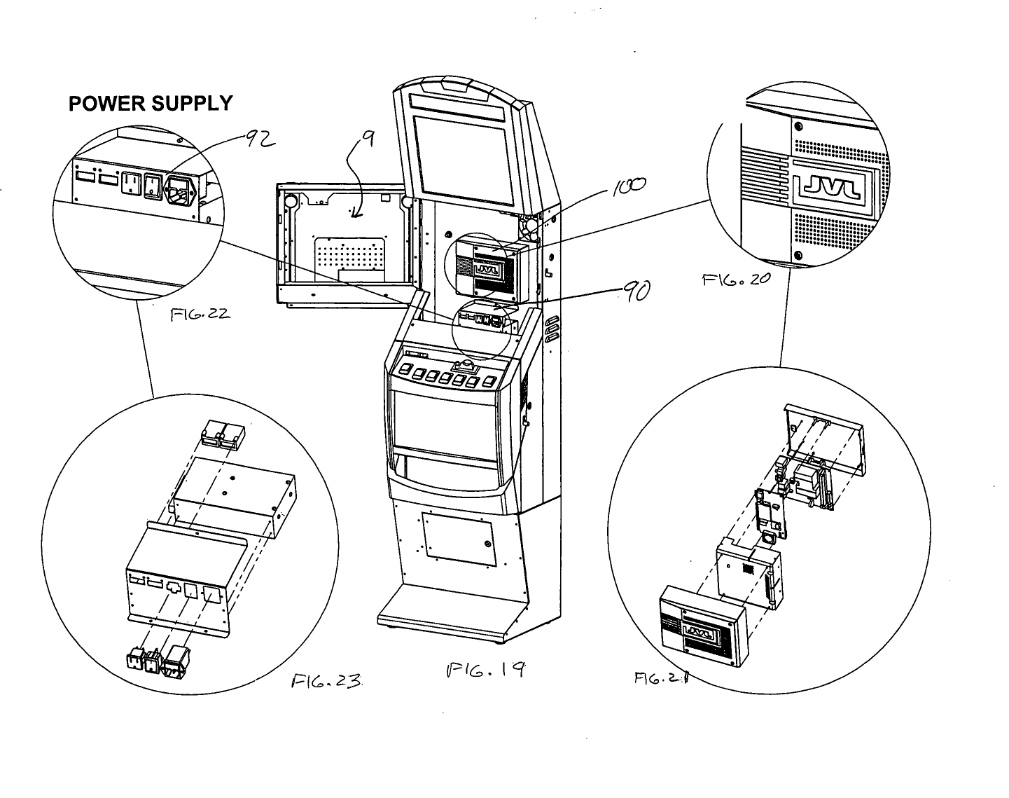

The hinged access panel 9 allows access to the rear of the video display screen 12 and it can be seen that the interior of the mid portion includes a fan 60 for cooling of the electronic components provided in the mid portion. The mid portion 6 also includes the amplifying and electronic arrangement 70 of the audio system. This system is connected to the game control as well as to the separate music control to allow the terminal to play either selected music or games. It is coordinated with the game processing arrangement shown as 80. The output of the audio system is fed to the speakers as shown in FIGS. 14 through 18.

FIG. 19 also shows details of the power supply arrangement 90 that is accessible at the intermediate portion 8 when the access panel 9 has been moved to the access position of FIG. 19. The power supply unit 90 allows convenient connection of the various electronic components including the game processing unit 100, the electronic components of the audio system as well as the processing for various of the game inputs. If any of these components need replacing they can easily be connected and disconnected from the power supply 90. The power supply also includes a number of expansion ports that allow for additional components to be connected or disconnected. These additional ports are shown as 92 in FIG. 22. For example, the game terminal may be used initially with a marquee screen provided in the upper portion 10. At a later point, the user may determine that it is desirable to put in an additional video display screen. Such a video display screen can be installed and the power thereof connected to the power supply unit 90 using any of the additional power output ports shown as 92. Similarly, if any of the components need replacing they are easily connected and disconnected from this power supply.

The game power supply arrangement 100 is shown in additional details in FIG. 21. It can be seen that it is made up of its own control unit including its own cooling unit and circuit board and enclosed box. This allows easy replacement of the module in the game terminal.

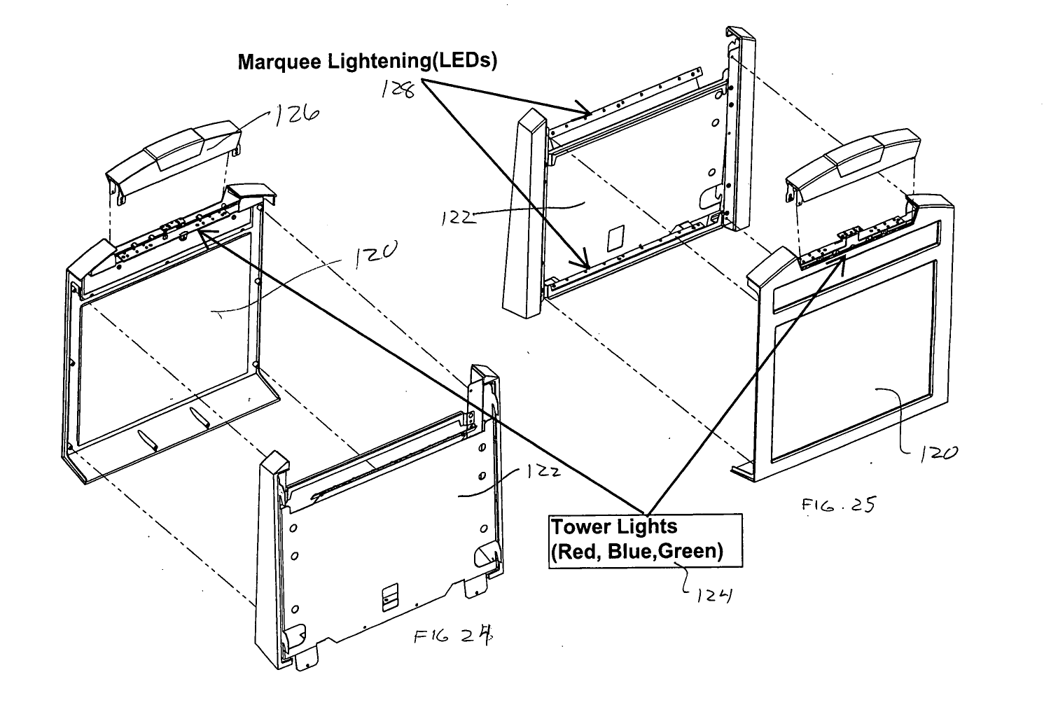

FIGS. 24 and 25 show details of the upper portion 10 and in particular the frame components thereof providing lighting to the upper portion and/or a structure for supporting of a video display screen. This arrangement includes a front cover arrangement 120 that is mechanically connected to the rear support frame 122. The rear support frame is mechanically connected to the intermediate portion 8. Tower lights can be provided and are generally indicated as 124. These are part of the attract mode at the upper portion of the terminal. A suitable lens arrangement 126 can enhance the lighting effect. As previously mentioned, a translucent marquee panel may be provided, and this could be panel 120. To increase the visual effect thereof, background lighting is provided in the rear frame 122 at position 128.

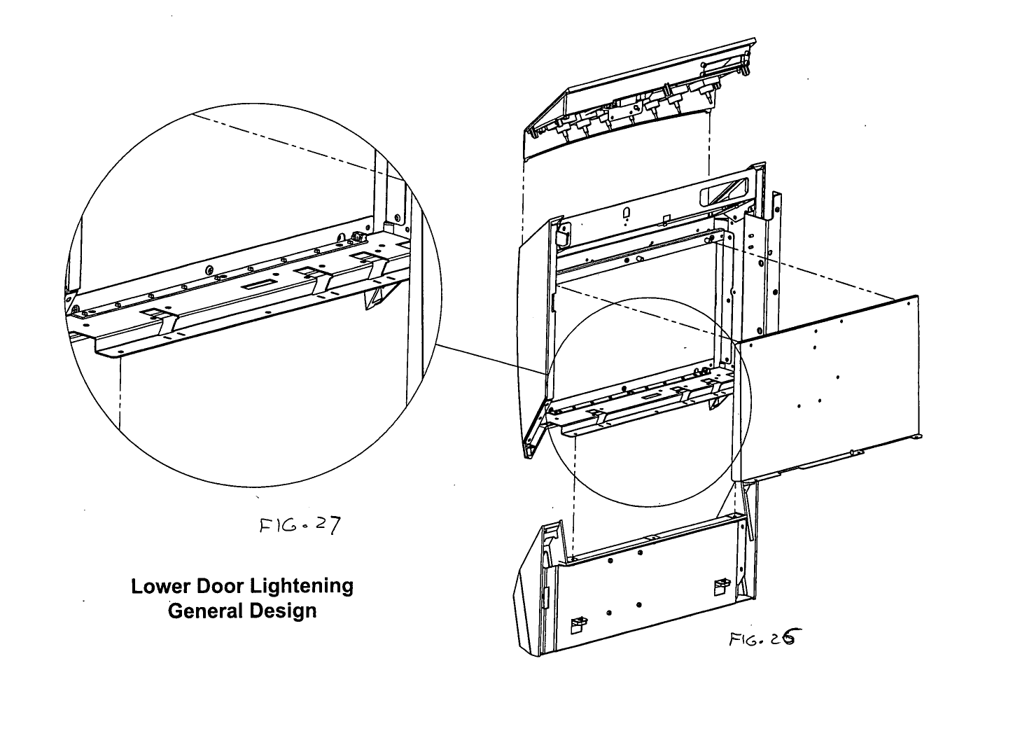

FIGS. 26 and 27 show some structural details provided at the access panel 7 for illuminating the mid portion 6 of the video game terminal. In particular, it shows some lighting that is provided at the front of the mid portion to enhance the visual effect of the terminal.

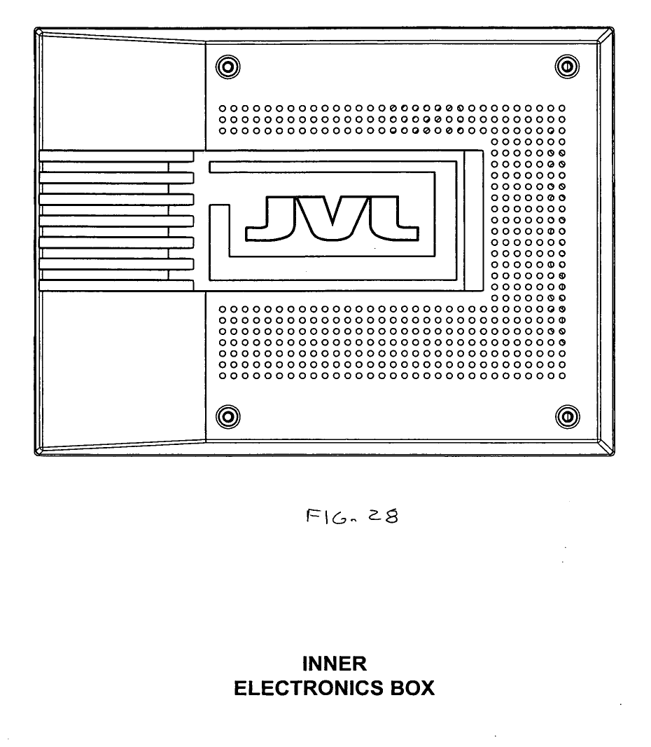

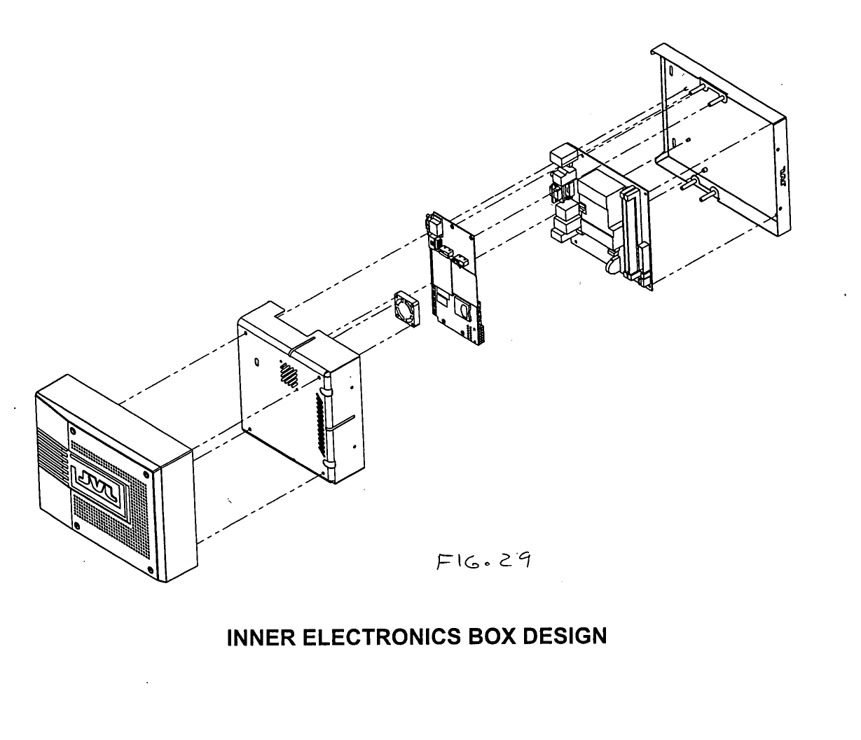

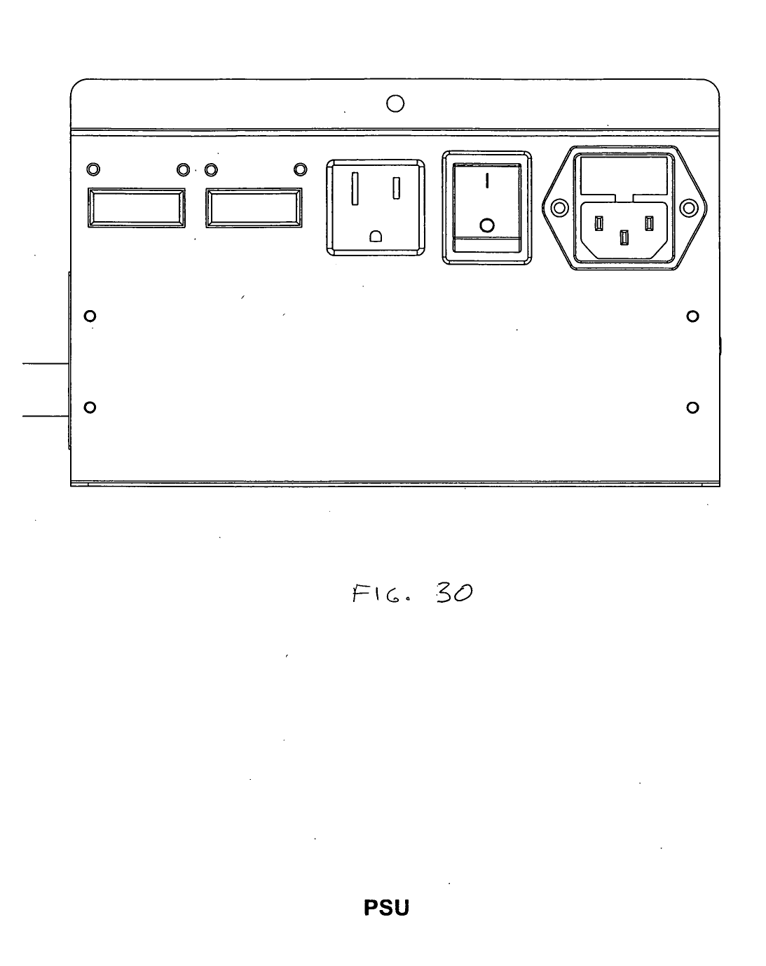

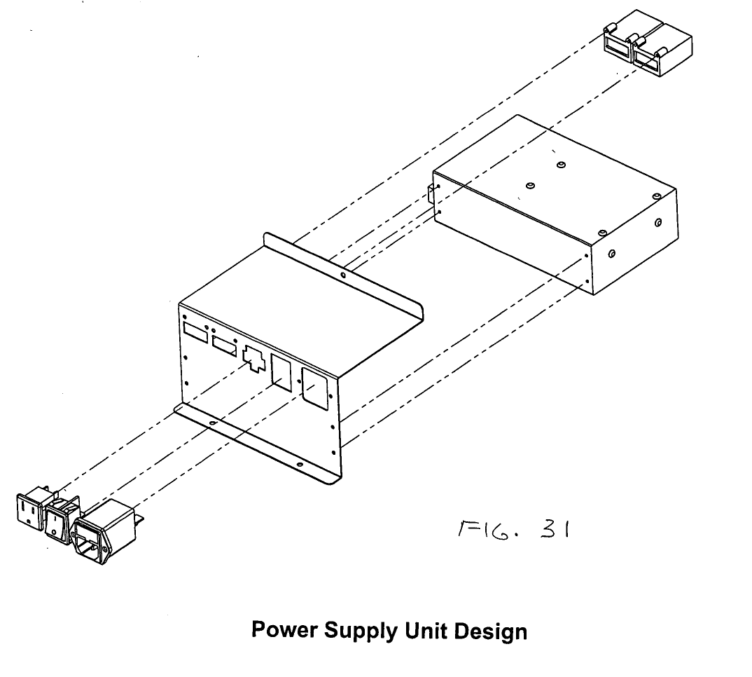

FIGS. 28 through 31 show details of the power supply unit of the game terminal. It is again a separate module with its own circuit boards and cooling fan for securement in the game terminal. As shown, it is of a modular design, and hence if there are any problems associated with the power supply unit it can easily be replaced.

For game terminals it is important to provide a terminal which is visually attractive to encourage players to at least consider the game terminal for play. Furthermore, it is desirable that the game terminal has an attract mode which includes both visual displays (either static or changing) and a high quality audio system. Typically, game terminals have not included such a high quality audio system, and the present terminal enhances this capability while still providing a space efficient design where the audio system forms part of the visual presentation of the terminal.

The video game terminal provides excellent access to the various components and allows simplified service. Furthermore, it is of a robust construction and is not prone to inadvertent user damage. As is well known, users of such game terminals may on occasion be physical and somewhat careless with respect to their use of the terminal. The present design provides a robust structure and is not prone to damage requiring repeated service.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A game terminal comprising a terminal frame divided into a lower portion, a mid portion, an intermediate portion and an upper portion, wherein said mid portion and said intermediate portion are each vertically split and include a hinged axis panel pivotal about a vertical edge of said terminal to provide front service access to said mid and intermediate portions, and wherein said terminal includes an elongate horizontally extending speaker system at a front face of said terminal at a junction of said intermediate and said upper portions.

2. A game terminal as claimed in claim 1 wherein said upper portion includes a removable front face supported by a rear frame and wherein said removable front face is replaceable allowing the front face to support a marquee panel or a video display screen.

3. A game terminal as claimed in claim 2 including a series of power and communication ports accessible by accessing said intermediate portion allowing a video display screen supported in said removable front face to be electronically connected to other electronic components of said game terminal.
